(19) United States
(12) Patent Application Publication
(10) Pub. No.: US 2007/0114281 A1
(43) Pub. Date: May 24, 2007

(54) Card reader having contact and non-contact interface

(75) Inventors: Gerald Kersch, Stallhofen (AT); Holger Kunkat, Neumuenster (DE); Paul Hubmer, Hart-Purgstall (AT)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: KONINKLIJKE PHILIPS ELECTRONICS N.V., EINDHOVEN (NL)

(21) Appl. No.: 10/569,593

(22) PCT Filed: Aug. 24, 2004
(86) PCT No.: PCT/IB04/51545

§ 371 Date: Dec. 5, 2006

(30) Foreign Application Priority Data
Aug. 27, 2003 (EP) 03 103 234.5

(51) Int. Cl. G06K 7/00; G06K 7/06; G06K 7/08

(52) U.S. Cl. 235/440; 235/441; 235/451

(57) ABSTRACT

A system (1) for executing system functions, for example a PC system, contains, firstly, a contact-bound characteristics block-processing stage (9), which is designed to process a contact-bound characteristics block (ATR) transferable from a contactbound data carrier (40) to a contact-bound read-write station (16) and, as a consequence of this processing, to generate at least one control signal (CS 1, CS2, CS3), and, secondly, a contactless read-write device (14, 15) that is designed to co-operate with a contactless data carrier (20, 30) and which contains a contact-bound characteristics block-recognition stage (25, 35) for recognizing a contactless characteristics block (ATS, UID) transferred from the contactless data carrier (20, 30) to the contactless read-write device (14, 15), and, thirdly, a contact-bound characteristics block-generation stage (26, 36), which generates the contactbound characteristics block (ATR) by utilizing the recognized contactless characteristics block (ATS, UID) and feeds it to the contact-bound characteristics block-processing stage (9).

The invention relates to a system for executing system functions, which system contains at least the means mentioned below, that is to say, a contact-bound characteristics block-processing stage that is designed to process a contact-bound characteristics block transferable from a contact-bound data carrier to a contact-bound read-write device and as a consequence of the processing of the contact-bound characteristics block is designed to produce at least one control signal.

The invention relates furthermore to a method of generating a contact-bound characteristics block.

A system corresponding to the construction referred to above in the first paragraph is known, namely in the form of a personal computer system. The known system comprises a personal computer, which is equipped with a read-write device that conforms to the standard ISO 7816. The read-write device is thus of contact-bound construction and is constructed to co-operate with a contact-bound data carrier, namely with a contact-bound card, which contact-bound card likewise complies with the standard ISO 7816. The contact-bound read-write device comprises a contact-bound characteristics block-recognition stage, which is provided and designed to recognize a contact-bound characteristics block transferred from the contact-bound card to the contact-bound read-write device. The contact-bound characteristics block is the characteristics block defined in accordance with the standard ISO 7816, which bears the designation “Answer to Reset” and for which the abbreviation ATR is established and customary. The contact-bound characteristics block ATR is used in the initialization of cards according to ISO 7816 to identify the relevant card, wherein by means of the contact-bound characteristics block ATR inter alia the type of the relevant card and/or the capabilities of the relevant card and/or the manufacturer of the relevant card and/or the distributor of the relevant card and suchlike are communicated to the read-write device. The communicated contact-bound characteristics block is processed by means of the contact-bound characteristics block-processing stage, wherein as a consequence of processing the contact-bound characteristics block ATR a plurality of control signals with or control commands are generated that are utilized to control various portions or regions of the known system. For example, a control signal for enabling the known system is generated. By means of other generated control signals, an automatic activation of various system functions of the known system is performed.

The known system has the limitation that the above-mentioned control signals or control commands can be generated only by means of a contact-bound data carrier and a read-write device provided and constructed for co-operating with contact-bound data carriers. It is therefore always necessary to bring a contact-bound data carrier into contact connection with the contact-bound read-write device, which relatively often requires an inconvenient and consequently not especially desirable operation.

It is an object of the invention to eliminate the above-mentioned problems and to produce an improved system corresponding to the construction mentioned in the introduction in the first paragraph. It is a further object of the invention to produce a new method of creating a contact-bound characteristics block.

To achieve the above-mentioned object, in a system according to the invention features according to the invention are provided so that a system according to the invention can be characterized in the manner specified below, namely:

A system for executing system functions, which system contains at least the means mentioned below, namely a contact-bound characteristics block-processing stage, which is designed to process a contact-bound characteristics block transferable from a contact-bound data carrier to a contact-bound read-write station and which, as a consequence of the processing of the contact-bound characteristics block, is designed to generate at least one control signal, and a contactless read-write device, which is designed to co-operate with a contactless data carrier and which contains a contactless characteristics block-recognition stage, which is designed to recognize a contactless characteristics block transferred from the contactless data carrier to the contactless read-write device, and a contact-bound characteristics block-generation stage, which is designed to process the contactless characteristics block recognized with the contactless characteristics block-recognition stage and which, as a consequence of the processing of the contactless characteristics block, is designed to generate the contact-bound characteristics block, which contact-bound characteristics block, which was generated by processing the contactless characteristics block, can be fed to the contact-bound characteristics block-processing stage.

To achieve the above-mentioned object, in a system according to the invention features according to the invention are provided so that a method according to the invention can be characterized in the manner specified below, namely:

A method of generating a contact-bound characteristics block, which method contains the method steps mentioned below, namely, feeding a contactless characteristics block to a contactless characteristics block-recognition stage and recognizing the contactless characteristics block with the contactless characteristics block-recognition stage and feeding the recognized contactless characteristics block to a contact-bound characteristics block-generation stage and processing the fed contactless characteristics block with the contact-bound characteristics block-generation stage and generating the contact-bound characteristics block with the contact-bound characteristics block-generation stage as a consequence of the processing of the contactless characteristics block with the contact-bound characteristics block-generation stage.

By providing the features according to the invention, in a simple manner and with only modest additional expense, in a system according to the invention it is possible to generate control signals or control commands for the signal-processing circuit of the system according to the invention by means of a contactless data carrier and a contactless read-write device co-operating with the contactless data carrier. By this means the generation of the control signals or control commands is activatable in a substantially more convenient and more expedient manner. By providing the features according to the invention, in particular the great advantage is achieved that in a system according to the invention, apart from, firstly, the contactless read-write device with the contactless characteristics block-recognition stage and, secondly, the contact-bound characteristics block-generation stage, by means of which the contact-bound characteristics block is generated using the contactless characteristics block, only circuit components already known and therefore available can be used, namely, the known contact-bound characteristics block-processing stage, which is provided and designed to generate the control signals or control functions for the signal-processing circuit of the system according to the invention, and the signal-processing circuit controllable by means of the contact-bound characteristics block-processing stage. Thus, also in a system according to the invention the control of the signal-processing circuit can be effected by means of the control signals or control commands in exactly the same way as is known from the known existing system, because generation of the control signals or control functions is effected also in the system according to the invention on the basis of the contact-bound characteristics block, which was generated here by utilizing and processing the contactless characteristics block.

In a system according to the invention, just one contactless read-write device can be provided with a contactless characteristics block-recognition stage. It has proved especially advantageous, however, when a system according to the invention is additionally provided with a contact-bound read-write device, which is designed to co-operate with a contact-bound data carrier and contains a contact-bound characteristics block-recognition stage, which is designed to recognize a contact-bound characteristics block transferred from the contact-bound data carrier to the contact-bound read-write device, which contact-bound characteristics block that was recognized by the contact-bound characteristics block-recognition stage can be fed to the contact-bound characteristics block-processing stage. This ensures the advantage that the generation of control signals or control commands for the signal-processing circuit of the system according to the invention is activatable both by means of a contactless data carrier and by means of a contact-bound data carrier.

In a system according to the invention the contact-bound region can comply with different possibilities, conventions and specifications. In a system according to the invention it has proved very advantageous, however, when the contact-bound region conforms to the standard according to ISO 7816. In this connection, it has proved advantageous when in a system according to the invention the features as claimed in claim 3 are provided.

In a system according to the invention the contactless region can comply with different possibilities, conventions and specifications. In a system according to the invention it has proved very advantageous, however, when the contactless region conforms to the standard according to ISO 14443-4. In this connection, it has proved advantageous when in a system according to the invention additionally the features as claimed in claim 4 are provided. In this instance, the contactless characteristics block is a characteristics block defined in the standard according to ISO 14443-4, which bears the designation “Answer To Select” and for which the abbreviation ATS is established and customary.

In a system according to the invention it has also proved very advantageous, however, when the contactless region conforms to the standard according to ISO 14443-3. In this connection, it has proved advantageous when in a system according to the invention additionally the features as claimed in claim 5 are provided. In this instance, the contactless characteristics block is a characteristics block defined in the standard according to ISO 14443-3, which bears the designation “Unique Identifier” and for which the abbreviation UID is established and customary.

In a system according to the invention it has furthermore proved very advantageous, however, when the contactless region conforms to the standard according to ISO 15693-3. In this connection, it has proved advantageous when in a system according to the invention additionally the features as claimed in claim 6 are provided. In this instance, the contactless characteristics block is a characteristics block defined in the standard according to ISO 15693-3, which bears the designation “Unique Identifier” and for which the abbreviation UID is established and customary.

A system according to the invention can be formed, for example, by an audio/video system from the entertainment electronics sector. Furthermore, a system according to the invention can be formed by a communications system. It has proved especially advantageous when the system according to the invention is in the form of a personal computer system.

These and other aspects of the invention are apparent from and will be elucidated, by way of non-limitative example, with reference to the embodiments described hereinafter.

In the drawings:

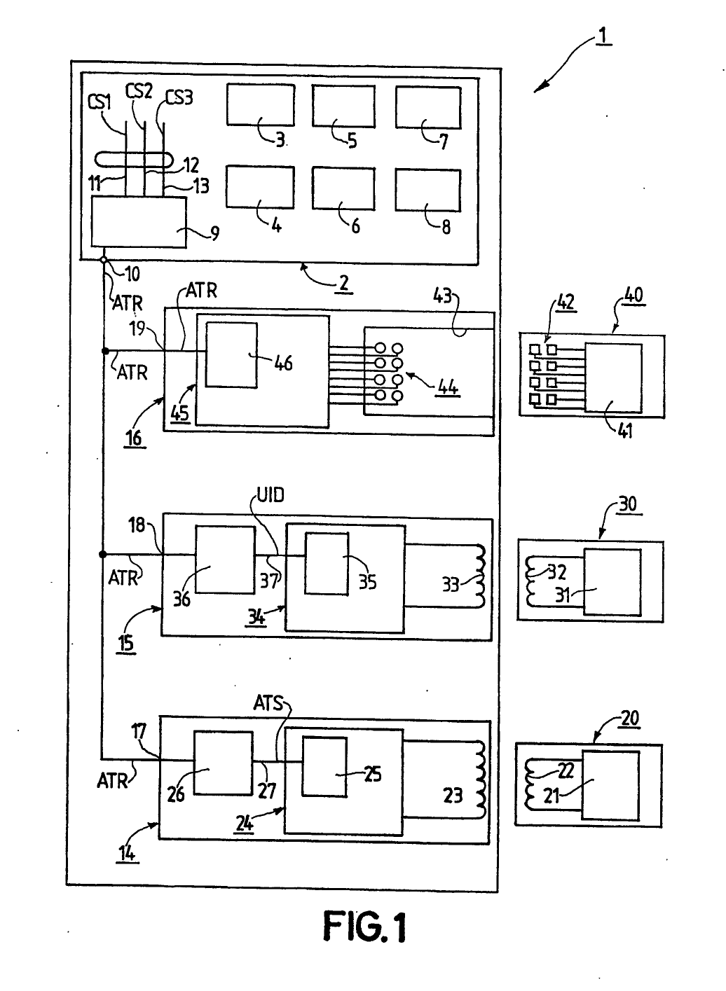

FIG. 1 shows a system according to an exemplary embodiment of the invention in the form of a block diagram.

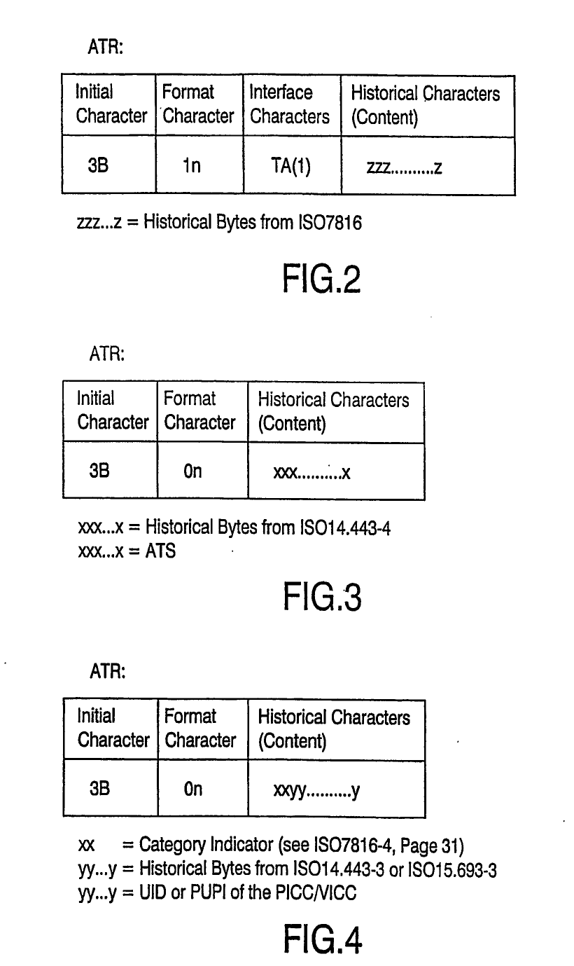

FIG. 2 shows schematically the construction of the contact-bound characteristics block according to the ISO 7816 standard.

FIG. 3 shows schematically the construction of a contact-bound characteristics block, which was produced by means of a contactless characteristics block according to the ISO 14443-4 standard.

FIG. 4 shows schematically the construction of a contact-bound characteristics block, which was produced by means of a contactless characteristics block according to the ISO 14443-4 or ISO 15693-3 standard.

FIG. 1 shows a system 1 for executing system functions. The system 1 is a personal computer system, which is provided and designed to execute a plurality of system functions, as has long been known per se.

The system 1 contains a signal-processing circuit 2. The signal-processing circuit 2 contains a plurality of signal-processing means, of which six signal-processing means are indicated schematically in FIG. 1. A first signal-processing means 3 is provided and designed for text-processing using a text-processing program. A second signal-processing means 4 is provided and designed for data-processing in spreadsheet form using a spreadsheet-processing program. A third signal-processing means 5 is provided and designed for receiving and sending e-mails using an e-mail-processing program. A fourth signal-processing means 6 is provided and designed for internet inquiry using an internet inquiry program. In FIG. 1, a fifth signal-processing means 7 and a sixth signal-processing means 8 are also indicated, but no details of their function are given here.

The signal-processing means 2 contains a contact-bound characteristics block-processing stage 9. A contact-bound characteristics block ATR can be fed to the contact-bound characteristics block-processing stage 9 via a connection 10 of the signal-processing circuit 2. Such a contact-bound characteristics block ATR is, as has long been known per se, transferable from a contact-bound data carrier to a contact-bound read-write station. The contact-bound characteristics block-processing stage 9 is provided and designed for processing the contact-bound characteristics block ATR. In consequence of the processing of the contact-bound characteristics block ATR, the contact-bound characteristics block-processing stage 9 is designed to generate in this instance three control signals CS1, CS2, CS3. The three control signals CS1, CS2, CS3 are provided for control of a respective portion of the signal-processing circuit 2. Each of the three control signals CS1, CS2, CS3 can be fed via a line 11, 12, 13 to the portion of the signal-processing circuit 2 to be controlled. The provision of such a contact-bound characteristics block-processing stage 9 and the generation and output of at least one control signal CS1, CS2, CS3 have long been known per se, and for that reason are not described in detail here.

The control signals CS1, CS2, CS3 are utilized for different control purposes. The control signal CS1 serves to enable the signal-processing circuit 2 of the system 1. The control signals CS2 and CS3 serve for other purposes, details of which are not given here since this is not essential to the present invention. For example, the control signals CS2 and CS3 can serve to enable peripherals connected up to the system 1.

It should be mentioned that the contact-bound characteristics block-processing stage 9 can also be provided outside the signal-processing circuit 2 of the system 1, in which case the control signals CS1, CS2, CS3 generated with the contact-bound characteristics block-processing stage 9 can then be fed to the signal-processing circuit 2 via the lines 11, 12, 13.

The system 1 contains a first contactless read-write device 14 and a second contactless read-write device 15 and a contact-bound read-write device 16. Each of the three devices 14, 15, 16 has an output 17, 18, 19. All three outputs 17, 18, 19 are connected to the connection 10 of the signal-processing circuit 2.

The first contactless read-write device 14 is designed in compliance with the ISO 14443-4 standard. The second contactless read-write station 15 is designed in compliance with the ISO 14443-3 standard. In an alternative embodiment of the system 1 the second contactless read-write station 15 is designed in compliance with the ISO 15693-3 standard. The contact-bound write device 16 is designed in compliance with the ISO 7816 standard.

The first contactless read-write station 14 is designed to co-operate with a first contactless data carrier 20. The first contactless data carrier 20 is designed to conform to the standard ISO 144434-4. The first contactless data carrier 20 comprises an IC 21 and a data carrier transmission coil 22 connected to the IC 21. The first contactless read-write device 14 comprises a first transmission coil 23, which is provided for contactless communication with the data carrier transmission coil 22 of the first data carrier 20. Connected with the first transmission coil 23 is a first signal-processing circuit 24, which is provided and designed to process all signals appearing in the first contactless read-write device 14. The first signal-processing circuit 24 contains a first contactless characteristics block-recognition stage 25, which is provided and designed to recognize a first contactless characteristics block ATS transmitted from the first contactless data carrier 20 to the first contactless read-write device 14. This first contactless characteristics block ATS is defined in the standard according to ISO 14443-4.

The first contactless read-write device 14 advantageously contains a first contact-bound characteristics block-generation stage 26. The first contactless characteristics block ATS recognized by means of the first contactless characteristics block-recognition stage 25 can be fed to the first contact-bound characteristics block-generation stage 26 via a connection 27. The first contact-bound characteristics block-generation stage 26 is designed to process the first contact-bound characteristics block ATS recognized with the first contactless characteristics block-recognition stage 25. Furthermore, in consequence of processing the first contactless characteristics block ATS, the first contact-bound characteristics block-generation stage 26 is designed to generate the contact-bound characteristics block ATR, which contact-bound characteristics block ATR, which was generated by processing of the first contactless characteristics block ATS, can be or is fed via the output 17 and the connection 10 to the contact-bound characteristics block-processing stage 9.

The second contactless read-write station 15 is designed to co-operate with a second contactless data carrier 30. The second contactless data carrier 30 is constructed to conform to the standard ISO 14443-3. The second contactless data carrier 30 comprises an IC 31 and a data carrier transmission coil 32 connected to the IC 31. The second contactless read-write device 15 comprises a second transmission coil 33, which is provided for contactlcss communication with the data carrier transmission coil 32 of the second data carrier 30. Connected with the second transmission coil 33 is a second signal-processing circuit 34, which is provided and designed to process all signals appearing in the second contactless read-write device 15. The second signal-processing circuit 34 contains a second contactless characteristics block-recognition stage 35, which is provided and designed to recognize a second contactless characteristics block UD transmitted from the second contactless data carrier 30 to the second contactless read-write device 15. This second contactless characteristics block UID is defined in the standard according to ISO 14443-3.

The second contactless read-write device 15 advantageously contains a second contact-bound characteristics block-generation stage 36. The second contact-bound characteristics block UID recognized by means of the second contactless characteristics block-recognition stage 35 can be fed to the second contact-bound characteristics block-generation stage 36 via a connection 37. The second contact-bound characteristics block-generation stage 36 is designed to process the second contact-bound characteristics block UID recognized with the second contactless characteristics block-recognition stage 35. Furthermore, in consequence of processing the second contactless characteristics block UID, the second contact-bound characteristics block-generation stage 36 is designed to generate the contact-bound characteristics block ATR, which contact-bound characteristics block ATR, which was generated by processing of the second contactless characteristics block UID, can be or is fed via the output 18 and the connection 10 to the contact-bound characteristics block-processing stage 9.

The contact-bound read-write device 16 is provided and designed to co-operate with a contact-bound data carrier 40. The contact-bound data carrier 40 is constructed to conform to the standard ISO 7816. The contact-bound data carrier 40 contains an IC 41 and a contact set 42 connected to the IC 41, which contact set contains in known manner a total of eight contacts, of which only five contacts however are used for signal transmission. The contact-bound read-write device 16 contains a receiving slot 43 into which the contact-bound data carrier 40 is insertable. In the region of the receiving slot 43, a counter-contact set 44 is provided, which is known manner likewise contains eight contacts, of which only five contacts however are used for signal transmission. Connected with the contacts of the counter-contact set 44 is a third signal-processing circuit 45, with which all signals appearing in the contact-bound read-write device 16 can be processed. The third signal-processing circuit 45 contains a contact-bound characteristics block-recognition stage 46, which is provided and designed to recognize the contact-bound characteristics block ATR transmitted from the contact-bound data carrier 40 to the contact-bound read-write device 16. Once the contact-bound characteristics block ATR has been recognized by means of the contact-bound characteristics block-recognition stage 46, the contact-bound characteristics block ATR can be fed via the output 19 and the connection 10 to the contact-bound characteristics block-processing stage 9.

With regard to the data carriers 20, 30 and 40, it should also be mentioned that in the present case these are card-form data carriers. The two contactless data carriers 20 and 30 need not necessarily be in card form, however, but could also be in other forms, for example key form or bar form.

The construction of the contact-bound characteristics block ATR according to the ISO 7816 standard recognized by means of the contact-bound characteristics block-recognition stage 46 is illustrated in FIG. 2. The contact-bound characteristics block ATR comprises an “initial character” and a “format character” and a specific number of “interface characters” and so-called “historical characters”, which are also known as “content”. The initial character and the format character each comprise one byte each having eight (8) bits. The interface characters comprise several bytes. The historical characters (content) comprise a maximum of fifteen (15) bytes. The initial character is, for example, “3B”. The format character is, for example, “In”. The interface characters are, for example, given by “TA(1)”. The historical characters are, for example, indicated by zzz . . . z.

In the case of the contact-bound characteristics block ATR illustrated in FIG. 3, the contact-bound characteristics block ATR is the one generated by means of the first contact-bound characteristics block-generation stage 26 of the first contactless read-write device 14. This contact-bound characteristics block ATR differs from the contact-bound characteristics block ATR according to the ISO 7816 standard, firstly, in that this contact-bound characteristics block ATR generated does not contain interface characters and, secondly, in that the historical characters are formed by the contactless characteristics block ATS according to the ISO 14443-4 standard, that is by the historical bytes according to the ISO 14443-4 standard.

In the case of the contact-bound characteristics block ATR illustrated in FIG. 4, the contact-bound characteristics block ATR is the one generated by means of the second 10 contact-bound characteristics block-generation stage 36 of the second contactless read-write device 15. This contact-bound characteristics block ATR differs from the contact-bound characteristics block ATR according to the ISO 7816 standard, firstly, in that this contact-bound characteristics block ATR generated docs not contain interfacc characters and, secondly, in that the historical characters are formed by the contactless characteristics block UID according to the ISO 14443-3 standard, that is by the historical bytes according to the ISO 14443-3 standard, wherein a category index xx is placed in front of the historical characters, as is defined in the ISO 7816-4 standard, page 31.

Regarding the contact-bound characteristics blocks ATR illustrated schematically in FIGS. 2, 3, and 4, it is to be noted in summary that the structure of these contact-bound characteristics blocks ATR corresponds to the structure defined in the standard according to ISO 7816 and that only the content of the contact-bound characteristics blocks is partially different. Owing to the fact that the structure of all three contact-bound characteristics blocks according to FIGS. 2, 3 and 4 corresponds to the standard according to ISO 7816, the great advantage is obtained that all contact-bound characteristics blocks can be recognized and can be processed by the contact-bound characteristics block-processing stage 9. Thus, by means ofjust a single characteristics block processing stage. provided in the system 1, namely by means of the contact-bound characteristics block-processing stage 9, it is possible to generate control signals CS1, CS2, CS3 that are released either by two different contactless data carriers 20 or 30 or which are released by a contact-bound data carrier 40 different from the two different contactless data carriers 20 or 30.

In the system 1 described above with reference to FIG. 1, two contactless read-write devices 14 and 15 and additionally a contact-bound read-write device 16 are provided. In a modification of the system 1, a third and optionally a fourth contactless read-write device can be provided. In a further modification of the system 1 according to FIG. 1, two or even more than two contact-bound read-write devices that conform to different standards or conventions or agreements could be formed by a single combined read-write device, which is often known as a multiprotocol reader. In a further modification of the system 1 according to FIG. 1, alternatively just one contactless read-write device jointly with a contact-bound read-write device can be provided. In a further modification of the system 1 according to FIG. 1, alternatively just one contactless read-write device on its own can be provided, in which case neither a contact-bound read-write device 16 nor a further contactless read-write device is provided.

It should moreover be mentioned that in the system 1 according to FIG. 1 the contact-bound characteristics block-generation stages 26 and 36 need not necessarily be components of the contactless read-write devices 14 and 15, but may also be components of the signal processing circuit 2 or may even be provided separately from the contactless read-write devices 14 and 15 and the signal-processing circuit 2.

1. A system for executing system functions, which system contains at least the means mentioned below, that is to say, a contact-bound characteristics block processing stage that is designed to process a contact-bound characteristics block transferable from a contact-bound data carrier to a contact-bound read-write device and as a consequence of the processing of the contact-bound characteristics block is designed to produce at least one control signal and a contactless read-write device which is designed to co-operate with a contactless data carrier and which contains a contactless characteristics block-recognition stage which is designed to recognize a contactless characteristics block transferred from the contactless data carrier to the contactless read-write device, and a contact-bound characteristics block-generation stage which is designed to process the contactless characteristics block recognized with the contactless characteristics block-recognition stage and which, as a consequence of the processing of the contactless characteristics block is designed to generate the contact-bound characteristics block, which contact-bound characteristics block which was generated by processing the contactless characteristics block, can be fed to the contact-bound characteristics block-processing stage.

2. A system as claimed in claim 1, having a contact-bound read-write device which is designed to co-operate with a contact-bound data carrier and which contains a contact-bound characteristics block-recognition stage which is designed to recognize a contact-bound characteristics block transmitted from the contact-bound data carrier to the contact-bound read-write device which contact-bound characteristics block which was recognized with the contact-bound characteristics block-recognition stage, can be fed to the contact-bound characteristics block-processing stage.

3. A system as claimed in claim 2, wherein the contact-bound characteristics block-processing stage is designed to process a contact-bound characteristics block conforming to the standard according to ISO 7816 and transferred from a contact-bound data carrier conforming to the standard according to ISO 7816 to a contact-bound read-write device conforming to the standard according to ISO 7816.

4. A system as claimed in claim 1, wherein the contactless characteristics block-recognition stage is designed to recognize a contactless characteristics block (ATS) conforming to the standard according to ISO 14443-4 and transferred from a contactless data carrier conforming to the standard according to ISO 14443-4 to a contactless read-write device conforming to the standard according to ISO 14443-4.

5. A system as claimed in claim 1, wherein the contactless characteristics block-recognition stage is designed to recognize a contactless characteristics block conforming to the standard according to ISO 14443-3 and transferred from a contactless data carrier conforming to the standard according to ISO 14443-3 to a contactless read-write device conforming to the standard according to ISO 14443-3.

6. A system as claimed in claim 1, wherein the contactless characteristics block-recognition stage is designed to recognize a contactless characteristics block conforming to the standard according to ISO 15693-3 and transferred from a contactless data carrier conforming to the standard according to ISO 15693-3 to a contactless read-write device conforming to the standard according to ISO 15693-3.

7. A system as claimed in claim 1 wherein the system is in the form of a personal computer.

8. A method for generating a contact-bound characteristics block, which method contains the method steps mentioned below, namely, feeding a contactless characteristics block to a contactless characteristics block-recognition stage and recognizing the contactless characteristics block with the contactless characteristics block-recognition stage and feeding the recognized contactless characteristics block to a contact-bound characteristics block-generation stage and processing the fed contactless characteristics block with the contact-bound characteristics block-generation stage and generating the contact-bound characteristics block with the contact-bound characteristics block-generation stage as a consequence of processing the contactless characteristics block with the contact-bound characteristics block-generation stage.

9. A method as claimed in claim 8, which method contains the method steps mentioned below, namely feeding a contactless characteristics block conforming to the standard according to ISO 14443-4 to the contactless characteristics block-recognition stage and recognizing the contactless characteristics block conforming to the standard according to ISO 14443-4 with the contactless characteristics block-recognition stage and feeding the recognized contactless characteristics block conforming to the standard according to ISO 14443-4 to the contact-bound characteristics block-generation stage and processing the fed contactless characteristics block conforming to the standard according to ISO 14443-4 with the contact-bound characteristics block-generation stage and generating a contact-bound characteristics block conforming to the standard according to ISO 7816 with the contact-bound characteristics block-generation stage as a consequence of processing the contactless characteristics block conforming to the standard according to ISO 14443-4 with the contact-bound characteristics block-generation stage.

10. A method as claimed in claim 8, which method contains the method steps mentioned below, namely feeding a contactless characteristics block conforming to the standard according to ISO 14443-3 to the contactless characteristics block-recognition stage and recognizing the contactless characteristics block conforming to the standard according to ISO 14443-3 with the contactless characteristics block-recognition stage and feeding the recognized contactless characteristics block conforming to the standard according to ISO 14443-3 to the contact-bound characteristics block-generation stage and processing the fed contactless characteristics block conforming to the standard according to ISO 14443-3 with the contact-bound characteristics block-generation stage and generating a contact-bound characteristics block conforming to the standard according to ISO 7816 with the contact-bound characteristics block-generation stage as a consequence of processing the contactless characteristics block conforming to the standard according to ISO 14443-3 with the contact-bound characteristics block-generation stage.

11. A method as claimed in claim 8, which method contains the method steps mentioned below, namely feeding a contactless characteristics block conforming to the standard according to ISO 15693-3 to the contactless characteristics block-recognition stage and recognizing the contactless characteristics block conforming to the standard according to ISO 15693-3 with the contactless characteristics block-recognition stage and feeding the recognized contactless characteristics block conforming to the standard according to ISO 15693-3 to the contact-bound characteristics block-generation stage and processing the fed contactless characteristics block conforming to the standard according to ISO 15693-3 with the contact-bound characteristics block-generation stage 36 and generating a contact-bound characteristics block conforming to the standard according to ISO 7816 with the contact-bound characteristics block-generation stage as a consequence of processing the contactless characteristics block conforming to the standard according to ISO 15693-3 with the contact-bound characteristics block-generation stage.
